(19) United States
(12) Patent Application Publication
(10) Pub. No.: US 2003/0139991 A1
(43) Pub. Date: Jul. 24, 2003

(54) Method of and apparatus for account aggregation

(75) Inventor: Neal A. Schwartz, Mount Kisco, NY (US)

Correspondence Address: Michael Chan, NCR Corporation, 1700 South Patterson Blvd., Dayton, OH, 45479-0001, US

(73) Assignee: NCR Corporation

(21) Appl. No.: 10/348,145

(22) Filed: Jan. 21, 2003

(30) Foreign Application Priority Data
Jan. 22, 2002 (GB) 0201324.1

(51) Int. Cl. G06F 17/60

(52) U.S. Cl. 705/35

(57) ABSTRACT

There is provided a self-service terminal comprising a display and a network connection. The terminal also includes means for accessing financial information remotely held at a plurality of different locations and means for incorporating the retrieved information in a screen for displaying on the display.

This invention relates to a self-service terminal (SST), such as an automated teller machine (ATM).

### BACKGROUND TO THE INVENTION

It is common for individuals to have a variety of distinct financial accounts; such as, current accounts, deposit accounts, building society or savings & loan accounts, as well as loyalty cards, mortgages and shares. Also, as financial awareness increases amongst the general public it is desirable for them to have an “holistic” view of all of these different accounts so that they can make enlightened decisions regarding savings and investments. Given the fast pace of modem living and the rapid changes in stock markets it is desirable for people to have access to an overview of their specific financial situation throughout the day or night, whether or not they have access to their home computer.

### SUMMARY OF THE INVENTION

According to a first aspect of the invention there is provided a self-service terminal comprising a display and a network connection, and means for accessing financial information remotely held at a plurality of different locations and means for incorporating the retrieved information in a screen for displaying on the display.

Preferably, the means for incorporating the retrieved financial information in a screen includes a terminal program for executing a Web browser. Most preferably, the terminal program is operable to allocate screen space to the Web browser in accordance with predetermined formatting.

Preferably, the self-service terminal is an Automated Teller Machine.

According to a second aspect of the present invention there is provided a self-service terminal network comprising a plurality of terminals, each terminal comprising a display and a network connection, and means for accessing financial information remotely held at a plurality of different locations and means for incorporating the retrieved information in a screen for displaying on the display

Preferably, the means for incorporating the retrieved financial information in a screen includes a terminal program for executing a Web browser. Most preferably, the terminal program is operable to allocate screen space to the Web browser in accordance with predetermined formatting.

Preferably, the terminal is an Automated Teller Machine.

According to a third aspect of the present invention there is provided a method of operation of a self service terminal in order to present a user with aggregated account information in relation to a plurality of the user's accounts with individual financial institutions, the method including the steps of;

a) accessing financial information remotely held at a plurality of different locations and

b) incorporating the retrieved information in a screen for displaying on the display simultaneously.

Preferably, the means for incorporating the retrieved financial information in a screen includes a terminal program for executing a Web browser. Most preferably, the terminal program is operable to allocate screen space to the Web browser in accordance with predetermined formatting.

Preferably, the terminal is an Automated Teller Machine.

According to a fourth aspect of the present invention there is provided a system for presenting a user with aggregated account information in relation to a plurality of the user's accounts with individual financial institutions, the system including a plurality of self-service terminal each of which comprises a display and a network connection, and means for accessing financial information remotely held at a plurality of different locations and means for incorporating the retrieved information simultaneously in a screen for displaying on a display on the one of said terminals from which a request for said information originated.

Preferably, the means for incorporating the retrieved financial information in a screen includes a terminal program for executing a Web browser. Most preferably, the terminal program is operable to allocate screen space to the Web browser in accordance with predetermined formatting.

Preferably, the terminal is an Automated Teller Machine.

The term “screen” is used herein to denote the graphics, text, controls (such as menu options), and such like, that are displayed on an SST display; the term “screen” as used herein does not refer to the hardware (for example, the LCD, CRT, or touchscreen) that displays the graphics, text, controls, and such like. Typically, when a transaction is being entered at an SST, a series of screens are presented in succession on the SST display. For example, a first screen may request a user to insert a card, a second screen may invite the user to enter his/her PIN, a third screen may invite the user to select a transaction, and so on.

### BRIEF DESCRIPTION OF THE DRAWINGS

Embodiments of the invention will now be described, by way of example, and with reference to the drawings, in which:

FIG. 1 is a block diagram of an SST system in accordance with the invention;

FIG. 2 is a block diagram showing a terminal and a server of FIG. 1 in more detail;

FIG. 3 is a block diagram showing the terminal of FIG. 2 in more detail; and

FIG. 4 is a flow diagram illustrating the operation of the SST network of FIG. 1, by a user.

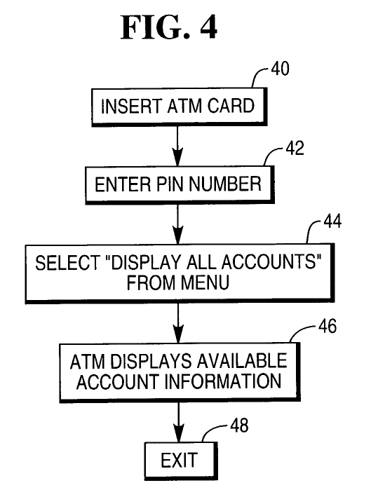

### DETAILED DESCRIPTION OF THE PREFERRED EMBODIMENT OF THE INVENTION

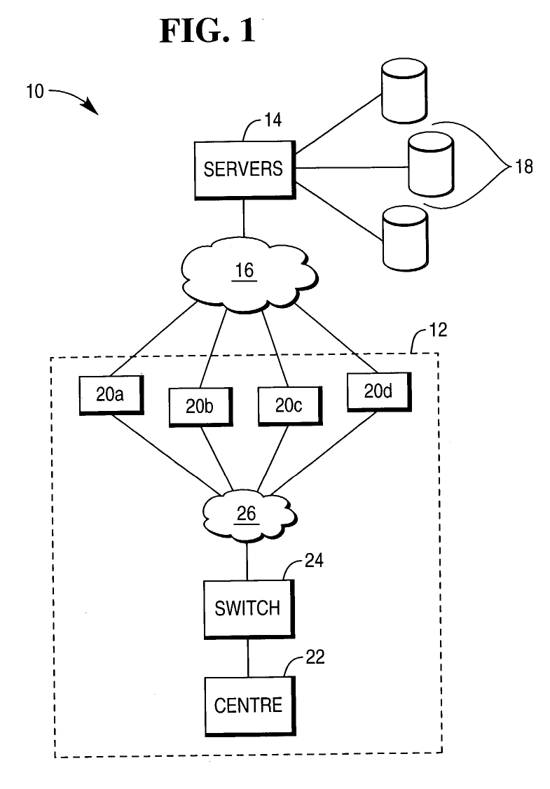

Referring to FIG. 1, which shows an SST system 10 in the form of an ATM system. ATM system 10 comprises an ATM network 12 connected to a plurality of servers 14 via a public access network 16 in the form of the Internet. The servers 14 are each connected to a database 18 relating to an independent financial institution, from which a user's account information (with that institution) can be accessed.

The ATM network 12 comprises a plurality of ATMs 20 (four of which; 20a, 20b, 20c, 20d, are shown in FIG. 1) interconnected to a financial institution's authorization center 22 via a switching device 24 and a secure private network 26 in the form of an Intranet.

Similarly to conventional ATM networks, the switching device 24 is used for routing financial transaction authorization requests from the ATMs 20 to the authorization center 22. As will be appreciated by those of skill in the art, the switching device 24 and the authorization center 22 may be incorporated into a single server (an authorization server). It will also be appreciated that the switching device 24 is able to route authorization requests to authorization centers operated by other financial institutions and to financial services companies. This format results in an inherently secure structure that is ideal for this form of information transmission.

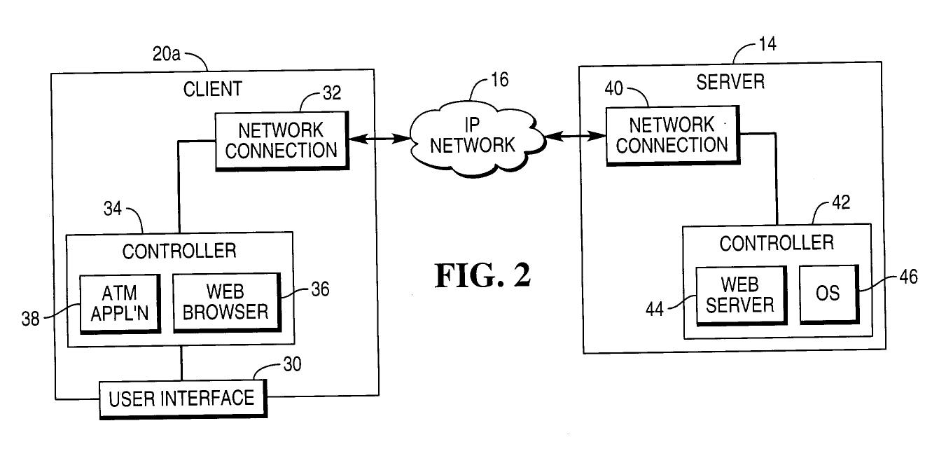

Reference is now made to FIG. 2, which is a block diagram showing one of the ATMs 20a and one of the servers 14 of FIG. 1 in more detail. ATM 20a operates as a client of a server 14 and includes: a user interface 30; a network connection 32 providing a link to the server 14 via the Internet 16; and a controller 34 for controlling the operation of the ATM 20a. The controller 34 incorporates an embedded Web browser component 36 and an ATM application 38 for controlling modules in the ATM 20a.

The server 14 also has a network connection 40 and a controller 42 incorporating a Web server 44 and a server operating system 46 for controlling the server 14.

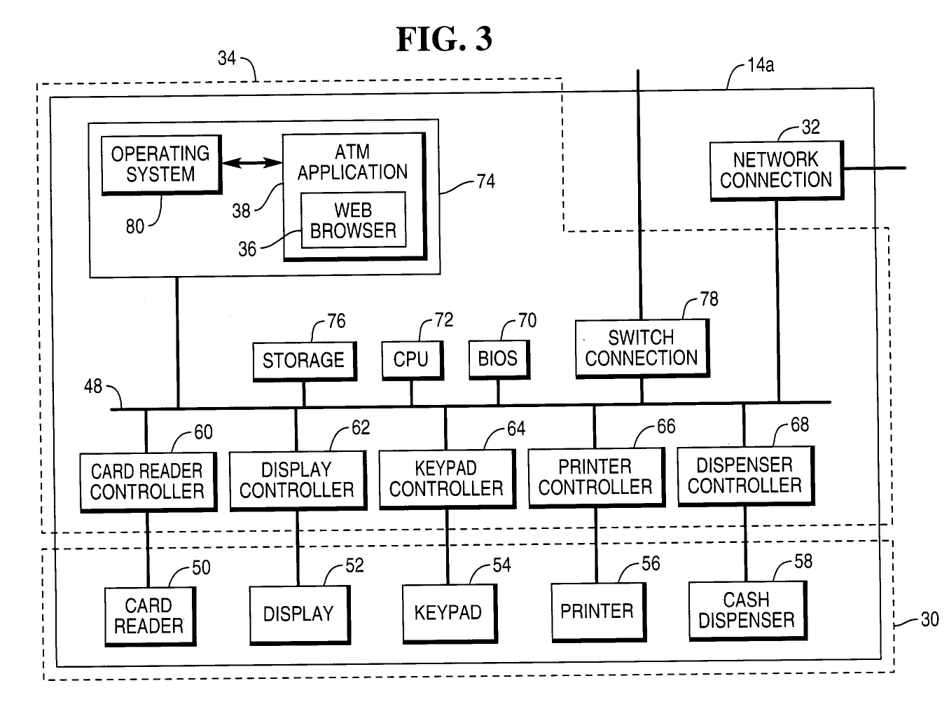

Referring to FIG. 3, which shows ATM 20a in more detail, a system bus (or a plurality of system buses) 48 interconnects the network connection 32 and the controller 34 to allow mutual intercommunication, and also connects various modules within the controller 34, as described below.

The user interface 30 comprises the following user interface elements (peripheral devices): a card reader 50, a display 52, an encrypting keypad 54, a printer 56, and a cash dispenser 58.

The controller 34 comprises modules for driving the user interface elements 50 to 58, namely: card reader controller 60, display controller 62, keypad controller 64, printer controller 66, and dispenser controller 68. These user interface elements (50 to 58) and associated controllers (60 to 68) are standard modules that are used on conventional ATMs and will not be described in detail herein.

The controller 34 also comprises a BIOS 70 stored in non-volatile memory, a microprocessor 72, associated main memory 74, storage space 76 in the form of a magnetic disk drive, and a dedicated switch connection 78 for connecting the ATM 20a to the authorization center 22 (FIG. 1).

The embedded Web browser component 36 is a HotJava (trade mark) browser bean component which is embedded within the ATM application 38. For simplicity, hereinafter the embedded browser component 36 will be referred to as a browser or a Web browser.

In use, the main memory 74 is loaded with the ATM operating system kernel 80, and the ATM application 38 for controlling the operation of the ATM 20a. The ATM application 38 includes the sequence of screens used in each transaction flow.

The financial institutions (or other third parties that have agreed with the financial institution to hold account information on their behalf) do so in a web enabled format. In this way the browser 36 can be utilized to interact with the financial institution in order to select required information and to pass it to the self-service terminal from which the request originated. The ATM application 38 that controls the presentation of screens on the display 52 is arranged to display the financial information from the different financial institutions in a single screen. This allows the user to see, at a glance, full up to date financial position.

When a user wishes to use this information at an ATM, he or she inserts their ATM card into a card reader slot (not shown) in the ATM (box 40). Then in response to a prompt the user inserts a personal identification number (PIN) (box 42). The ATM then automatically displays a “Menu” screen on the display 52, and the user selects the service required, in this case “Display all accounts” (box 44). The ATM then finds and displays all available account information relating to the user on a single screen (box 46). The user exits the screen by selecting the “Exit” key, which is also displayed on the screen (box 48).

Modifications may be made to the above-described embodiment within the scope of the present invention. For example, the account information may relate to non-financial accounts such as bonus points for loyalty schemes. Also, information may be presented in list format or other formats instead of windows format.

What is claimed is:

1. A self-service terminal comprising:
a display;
means for accessing financial information remotely held at a plurality of different locations; and
means for incorporating the financial information in a screen for displaying on the display.

2. A terminal as claimed in claim 1, wherein the means for incorporating the retrieved financial information in a screen includes a terminal program for executing a Web browser.

3. A terminal as claimed in claim 2, wherein the terminal program is operable to allocate screen space to the Web browser in accordance with predetermined formatting.

4. An automated teller machine (ATM) comprising:
a currency dispenser for dispensing currency to an ATM customer;
a display for displaying financial information to allow an ATM customer to view financial information;
means for accessing financial information remotely held at a plurality of different locations; and
means for incorporating the financial information in a screen for displaying on the display.

5. A self-service terminal network comprising:
a plurality of self-service terminals, each self-service terminal including a display, means for accessing financial information remotely held at a plurality of different locations, and means for incorporating the financial information in a screen for displaying on the display.

6. A network as claimed in claim 5, wherein the means for incorporating the financial information in a screen includes a terminal program for executing a Web browser.

7. A network as claimed in claim 6, wherein the terminal program is operable to allocate screen space to the Web browser in accordance with predetermined formatting.

8. A network as claimed in claim 5, wherein at least one of the plurality of self-service terminals comprises an automated teller machine (ATM).

9. A method of operating of a self service terminal to present a user with aggregated account information in relation to a plurality of the user's accounts with individual financial institutions, the method comprising the steps of:
(a) accessing financial information remotely held at a plurality of different locations; and
(b) incorporating the financial information in a screen for displaying on the display simultaneously.

10. A method as claimed in claim 9, wherein step (b) includes the step of:
(b-1) executing a Web browser to display the screen on the display simultaneously.

11. A method as claimed in claim 10, wherein step (b-1) includes the step of:
(b-1-1) allocating screen space to the Web browser in accordance with predetermined formatting.

12. A method as claimed in claim 9, wherein the self-service terminal comprises an automated teller machine (ATM).

13. A system for presenting a user with aggregated account information in relation to a plurality of the user's accounts with individual financial institutions, the system comprising:
a plurality of self-service terminals, each self-service terminal including a display, means for accessing financial information remotely held at a plurality of different locations, and means for incorporating the financial information simultaneously in a screen for displaying on the display of the self-service terminal from which a request for the financial information originated.

14. A system as claimed in claim 13, wherein the means for incorporating the financial information in a screen includes a terminal program for executing a Web browser.

15. A system as claimed in claim 14, wherein the terminal program is operable to allocate screen space to the Web browser in accordance with predetermined formatting.

16. A terminal as claimed in claim 13, wherein at least one of the self-service terminals comprises an automated teller machine (ATM).
